(19) United States
(12) Patent Application Publication
(10) Pub. No.: US 2018/0265379 A1
(43) Pub. Date: Sep. 20, 2018

(54) Water Purifier and Control Method For the Same

(71) Applicant: A.O. SMITH (NANJING) WATER TREATMENT PRODUCTS CO., LTD., Nanjing City (CN)

(72) Inventors: Lian XUE, Nanjing City (CN); Yan HUANG, Nanjing City (CN); Yaohua HE, Nanjing City (CN); Chen WANG, Nanjing City (CN); Hanling WANG, Nanjing City (CN); Li LI, Nanjing City (CN)

(21) Appl. No.: 15/983,516

(22) Filed: May 18, 2018

Related U.S. Application Data
(63) Continuation of application No. PCT/CN2016/106019, filed on Nov. 16, 2016.

(30) Foreign Application Priority Data
Nov. 20, 2015 (CN) 201510809043.9

(51) Int. Cl. C02F 1/44; C02F 1/00; C02F 5/08

(52) U.S. Cl. CPC C02F 1/441; C02F 1/008; C02F 2201/005; C02F 2303/16; C02F 5/08

(57) ABSTRACT

A control method for a water purifier includes establishing a first cleaning passage which communicates a scale inhibiting mechanism with an RO membrane element of the water purifier and through which the scale inhibiting mechanism cleans the RO membrane element for a first preset time. The method additionally includes establishing a draining passage which is connected to the scale inhibiting mechanism and through which liquid in the scale inhibiting mechanism is drained out, and establishing a second cleaning passage which is in communication with raw water and through which the RO membrane element is cleaned with the raw water for a second preset time.

### RELATED APPLICATIONS

The present application claims the priority of the Chinese patent application for application No. 201510809043.9, entitled “Water Purifier and Control Method for the same”, filed on Nov. 20, 2015, of which the entire contents are incorporated by reference in the present application.

### BACKGROUND

The present application relates to the field of water quality purification, in particular relates to a water purifier and a control method for the same.

Drinking water problem is a problem which the people concern very much. It has been an indisputable fact that many unhealthy substances exist in water, which is the main reason why ordinary people have enhanced their awareness of healthy drinking water, and is also the root of the prosperous market of water purifying devices. Water contains many harmful substances, such as impurities like sediments, oxides, suspended matters and various bacteria harmful to the human body. If water is not processed, drinking the water for years may influence the physical health. In prior arts, the water purification is hardly radical and causes more energy consumption.

In order to solve the above mentioned water drinking problem, reverse osmosis water purifiers (RO water purifier) are generally used at present to purify raw water. The RO water purifier produces pure water for drinking by human beings directly by pressurizing the raw water and performing a filtration treatment using physical principles, by a reverse osmosis filtration method, while no compound is added during the preparation process. The RO water purifier divides the raw water into pure water and waste water by means of an RO membrane in the water production process, and the waste water is discharged or used for other purposes after passing through the waste water proportioner. In order to avoid the problem of blockage caused by too many impurities accumulated in the waste water proportioner or on the RO membrane during the water production process, at present, a scale inhibiting mechanism is generally provided on a water production pipeline of the RO water purifier to thereby conduct complexation and absorption of ions such as Ca+ and Mg+ in the raw water or waste water, thus protecting the RO membrane and the waste water proportioner and avoiding scaling in the waste water proportioner.

However, in current water purifiers, the scale inhibiting mechanism is in a state of long-term immersion in water, so the scale inhibitor in the scale inhibiting mechanism is dissolved in water. As the time of immersion prolongs, the scale inhibitor will be caused to be consumed too fast after long-term dissolution, and thus there is a need to replace the scale inhibitor frequently, which increases the costs.

Moreover, along with the dissolution of the scale inhibitor and under the effect of time, some ions in the scale inhibitor may permeate to the pure water side of the RO membrane, thereby causing the problem of excessive ions in drinking water, which brings risks for the health of the users.

### SUMMARY

In view of the deficiencies of the prior arts, the present application provides a water purifier and a control method for the same to solve at least one of the above mentioned technical problems.

In order to achieve the above purpose, the present application provides a control method for a water purifier, comprising: establishing a first cleaning passage which communicates a scale inhibiting mechanism with an RO membrane element of the water purifier and through which the scale inhibiting mechanism cleans the RO membrane element for a first preset time; establishing a draining passage which is connected to the scale inhibiting mechanism and through which liquid in the scale inhibiting mechanism is drained out; and establishing a second cleaning passage which is in communication with raw water and through which the RO membrane element is cleaned with the raw water for a second preset time.

As a preferred embodiment, the method further comprises establishing a water production passage which is in communication with the raw water and through which pure water is produced.

As a preferred embodiment, the water purifier comprises a water inlet valve, a booster pump, the RO membrane element, the scale inhibiting mechanism and a waste water proportioner which are connected in sequence; said establishing a water production passage which is in communication with raw water and through which pure water is produced includes: opening the water inlet valve to establish the water production passage, and controlling the booster pump to run to produce pure water.

As a preferred embodiment, a water outlet of the scale inhibiting mechanism is in communication with a water inlet of the booster pump; said establishing a water production passage which is in communication with raw water and through which pure water is produced and said establishing a first cleaning passage which communicates a scale inhibiting mechanism with an RO membrane element of the water purifier and through which the scale inhibiting mechanism cleans the RO membrane element for a first preset time include: opening the water inlet valve to simultaneously establish the water production passage and the first cleaning passage; and controlling the booster pump to run so as to produce pure water and at the same time cause the scale inhibiting mechanism to clean the RO membrane element.

As a preferred embodiment, a water outlet of the scale inhibiting mechanism is in communication with a water inlet of the booster pump, and a first switch valve is provided therebetween; said establishing a water production passage which is in communication with raw water further includes: closing the first switch valve; said establishing a first cleaning passage which communicates a scale inhibiting mechanism with an RO membrane element of the water purifier and through which the scale inhibiting mechanism of the water purifier cleans the RO membrane element of the water purifier for a first preset time includes: opening the first switch valve and closing the water inlet valve to establish the first cleaning passage; and controlling the booster pump to run for the first preset time to cause the scale inhibiting mechanism to clean the RO membrane element of the water purifier.

As a preferred embodiment, said controlling the booster pump to run for the first preset time to cause the scale inhibiting mechanism to clean the RO membrane element of the water purifier includes: controlling the booster pump to run for the first preset time to cause the scale inhibiting mechanism to circularly clean the RO membrane element of the water purifier.

As a preferred embodiment, a second switch valve is provided between a water outlet of the RO membrane element and a water inlet of the scale inhibiting mechanism; a waste water outlet of the RO membrane element is connected with a flush valve; said establishing a water production passage which is in communication with raw water further includes: opening the second switch valve and closing the flush valve; said establishing a first cleaning passage which communicates a scale inhibiting mechanism with an RO membrane element of the water purifier further includes: opening the second switch valve and closing the flush valve; said establishing a draining passage which is connected to the scale inhibiting mechanism and through which liquid in the scale inhibiting mechanism is drained out includes: opening the first switch valve and the flush valve, and closing the water inlet valve and the second switch valve to establish the draining passage; and controlling the booster pump to run for a third preset time to drain the liquid in the scaling inhibition mechanism.

As a preferred embodiment, said establishing a second cleaning passage which is in communication with raw water and through which the RO membrane element is cleaned with the raw water for a second preset time includes: opening the water inlet valve and the flush valve, and closing the first switch valve and the second switch valve, so as to establish the second cleaning passage; and controlling the booster pump to run for the second preset time to clean the RO membrane element.

To achieve the above purpose, the present application also provides a water purifier, comprising: a water inlet valve, a booster pump, an RO membrane element, a scale inhibiting mechanism and a waste water proportioner which are connected in sequence; the scale inhibiting mechanism is connected with a draining passage capable of draining liquid in the scaling inhibition mechanism.

As a preferred embodiment, a water outlet of the scale inhibiting mechanism is in communication with a water inlet of the booster pump, and a first switch valve is provided therebetween.

As a preferred embodiment, a second switch valve is provided between a water outlet of the RO membrane element and a water inlet of the scale inhibiting mechanism; a waste water outlet of the RO membrane element is connected with a flush valve; the draining passage is established when the first switch valve and the flush valve are opened and the water inlet valve and the second switch valve are closed; and the booster pump is able to run to drain the liquid in the scale inhibiting mechanism.

As a preferred embodiment, the flush valve, the first switch valve and the second switch valve are all solenoid valves; and the water purifier further comprises a controller connected to each of the water inlet valve, the flush valve, the first switch valve and the second switch valve.

As a preferred embodiment, the scale inhibiting mechanism includes a sili phos scale inhibitor.

It can be seen from the above description that, by establishing the draining passage connected to the scale inhibiting mechanism, the control method for a water purifier provided by the present application can drain the liquid in the scale inhibiting mechanism in a state of not producing water, thereby effectively preventing the scale inhibitor in the scale inhibiting mechanism from being consumed too fast since it is in a dissolved state all the way. Meanwhile, in the method, the first cleaning passage is also established to realize the cleaning work of the RO membrane element, which can effectively avoid the problem of blockage of the RO membrane element, thus prolonging the service life of the RO membrane element. In addition, in the method, a second cleaning passage is also established. By such a setting, it is possible to wash off ions on the RO membrane, thereby avoiding the problem of excessive ions caused by the ions permeating to the pure water side of the RO membrane.

Please refer to the following Description and Figures, which have disclosed the specific embodiments of the present application in detail, and clearly pointed out the modes in which the principle of the present application may be applied. It should be understood that the embodiments of the present application will not be limited thereby in scope. The embodiments of the present application include a lot of alternations, modifications and equivalents within the scope of spirit and clauses of the appended claims.

Features that are described and/or illustrated with respect to one embodiment may be used in the same way or in a similar way in one or more other embodiments, in combination with or instead of the features of the other embodiments.

It should be emphasized that the term “comprises/comprising”, when used in this text, is taken to specify the presence of features, integers, steps or components, but does not preclude the presence or addition of one or more other features, integers, steps, or components.

### BRIEF DESCRIPTION OF THE DRAWINGS

In order to explain more clearly the embodiments in the present application or the technical solutions in the prior art, the following will briefly introduce the figures needed in the description of the embodiments or the prior art. Obviously, figures in the following description are only some embodiments of the present application, and for a person skilled in the art, other figures may also be obtained based on these figures without paying creative efforts.

FIG. 1 is a flow chart of the control method for a water purifier provided by one embodiment of the present application.

FIG. 2 is a piping diagram of the water purifier provided by one embodiment of the present application.

### DETAILED DESCRIPTION

Before any embodiments of the application are explained in detail, it is to be understood that the application is not limited in its application to the details of construction and the arrangement of components set forth in the following description or illustrated in the following drawings. The application is capable of other embodiments and of being practiced or of being carried out in various ways.

In order to enable persons skilled in the art to better understand the technical solutions in this application, a clear and comprehensive description to the technical solutions in the embodiments of the present application will be made in the following in combination with the figures in the embodiments of the present application, and obviously, the embodiments described herein are only part of the embodiments of the present application rather than all the embodiments of the present application. Based on the embodiments of the present application, all other embodiments obtained by ordinary skilled persons in the field without paying creative efforts should pertain to the extent of protection of the present application.

What needs to be explained is that, when an element is referred to as being “provided on” another element, it may be directly on the other element, or an intervening element may be present. When an element is considered to be “connected to” another element, it may be directly connected to the other element, or an intervening element may be present. The terms “perpendicular”, “horizontal”, “left” and “right” as well as similar expressions used in the text are only for the purpose of explanation, and do not represent the unique embodiment.

Unless otherwise defined, all technical and scientific terms used in the text have the same meaning as commonly understood by persons pertaining to the technical field of the present application. The terminology used in the Description of the present application is for the purpose of describing the specific embodiments only, and is not intended to limit the present application. The term “and/or” used in the text includes any and all combinations of one or more of the associated listed items.

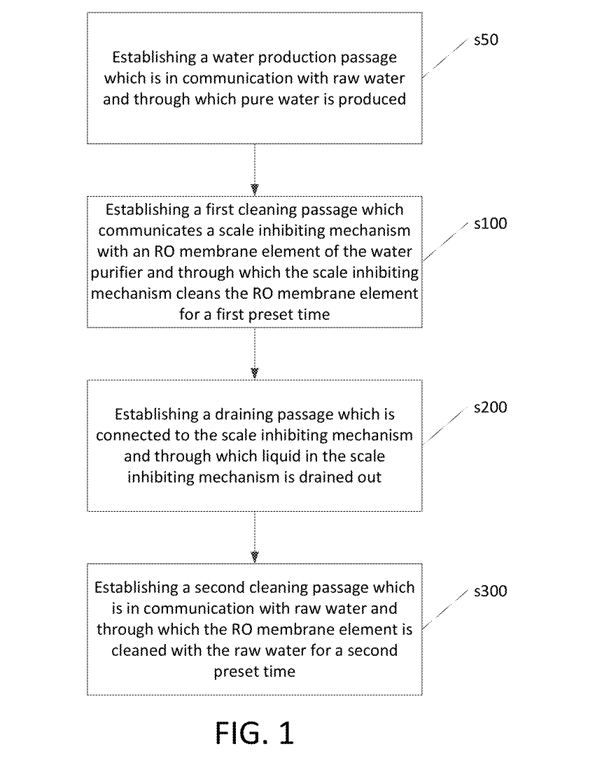

Please refer to FIG. 1. One embodiment of the present application provides a control method for a water purifier. The method is applied, but not limited to preventing the scale inhibitor of the water purifier from being consumed too fast and avoiding the problem of excessive ions. In this embodiment, the control method for a water purifier comprises the following steps:

S100: establishing a first cleaning passage which communicates a scale inhibiting mechanism with an RO membrane element of the water purifier and through which the scale inhibiting mechanism cleans the RO membrane element for a first preset time.

In this step, the water purifier communicates the scale inhibiting mechanism with the RO membrane element by means of the first cleaning passage. A liquid containing a scale inhibitor (dissolved) in the scale inhibiting mechanism is delivered into the RO membrane element via the first cleaning passage, and the liquid containing the scale inhibitor will clean the RO membrane when passing through the RO membrane (reverse osmosis membrane) of the RO membrane element, rinsing and taking away the impurities (such as Ca+ and Ma+ ions) on the RO membrane surface, thereby preventing occurrence of the problem of blockage of the RO membrane element, thus prolonging the service life of the RO membrane.

In the first cleaning passage, the RO membrane element and the scale inhibiting mechanism may be connected in series, and can also be connected in parallel. The present application does not make any limitation to this. A valve structure or a driving mechanism may be provided between the scale inhibiting mechanism and the RO membrane elemented. Of course, A booster pump in the water production passage may also be used to perform the actuation. Of course, in the step S100, a water outlet of the scale inhibiting mechanism is in communication with a water inlet of the RO membrane element, so that the liquid in the scale inhibiting mechanism is discharged into the RO membrane element.

As may be seen from the above depiction, the first cleaning passage and the other passage (such as the water production passage) in this embodiment may be different pipelines from each other (only the RO membrane element is the common part), while both passages may also be pipeline configurations that utilize part of the device on the other side's passages, so that the integration level of the pipelines of the water purifier is improved. Of course, when the water purifier establishes the first cleaning passage, the establishment may be realized only by controlling opening and closing of the valve on the pipeline, meanwhile, the purpose of cleaning the RO membrane element by the scale inhibiting mechanism is achieved by controlling the operation of the driving mechanism.

The RO membrane element is cleaned for the first preset time to ensure that the RO membrane element is effectively cleaned. In a case where the first cleaning passage is configured as a circulation pipeline, the liquid containing the scale inhibitor is allowed to pass through the RO membrane element circularly, so that the scale inhibiting mechanism circularly cleans the RO membrane, thereby accomplishing the effective cleaning of the RO membrane. Of course, in the first cleaning passage, the liquid containing the scale inhibitor is not necessarily used to perform the circular cleaning work, i.e., even in the first cleaning passage configured as a circulation pipeline, the liquid containing the scale inhibitor, after cleaning the RO membrane element once, may be discharged or can reenter the scale inhibiting mechanism. Besides, the first cleaning passage also does not have to be configured as a circulation pipeline, instead, it may also be configured as an acyclic pipeline as long as the liquid in the scale inhibiting mechanism is ensured to be able to clean the RO membrane element.

S200: establishing a draining passage which is connected to the scale inhibiting mechanism and through which liquid in the scale inhibiting mechanism is drained out.

In this step, the water purifier may be provided with an independent pipeline to establish the draining passage together with the scale inhibiting mechanism, so as to drain the liquid in the scale inhibiting mechanism, whereby the dissolution caused by long-term immersion of the scale exhibition mechanism in the liquid is avoided, which prevents the scale inhibitor from being consumed too fast, and thus the service life of the scale inhibiting mechanism may be effectively prolonged.

In this embodiment, the draining passage may be configured as an independent pipeline, and may also work together with the water production passage and the first cleaning passage. For example, when the draining passage is configured as an independent pipeline, the scale inhibiting mechanism may be connected with a discharge pipe and a suction device, and at the same time, the scale inhibiting mechanism is isolated in the first cleaning pipeline or the water production pipeline when draining the liquid. To be specific, the scale inhibiting mechanism may be isolated by additionally setting a valve. When the draining passage cooperates with the water production passage and the first cleaning passage, the draining passage may be formed by additionally setting a valve on the existing water production passage and first cleaning passage of the water purifier, or by controlling opening and closing of the existing valve.

It may be seen that, in this embodiment, the draining passage may have a plurality of configuration forms, and the present application does not make any limitation to this. Of course, when emptying the scale inhibiting mechanism, in order to balance a pressure inside the scale inhibiting mechanism, the existing waste water proportioner may be used to perform an air intake balancing, and it is also feasible to provide an additional pressure balancing mechanism to ensure smooth operation of the draining work.

When draining the liquid in the scale inhibiting mechanism, the suction mechanism may be the booster pump on the water production passage, and may also be the driving mechanism on the first cleaning passage, and of course may also be provided individually. For purposes of saving costs and improving the integration level of the pipelines, both the suction mechanism and the driving mechanism may be the booster pump on the water production passage.

What needs to be explained is that, the step S200 and step S100 do not have a clear execution sequence relationship therebetween. The step S200 may be executed before the step S100, may be executed after the step 100, and can also be executed in the midway through the step S100. The present application does not make any limitation to this. However, considering practical applications, the preferred solution of this embodiment is sequentially executing the steps S100 and S200.

S300: establishing a second cleaning passage which is in communication with raw water and through which the RO membrane element is cleaned with the raw water for a second preset time.

Although the RO membrane is cleaned with the liquid containing a scale inhibitor in the step S100 to prevent scaling and blockage of the RO membrane, it is possible that scale-inhibiting ions (such as phosphorus) are still remained on the RO membrane. Therefore, in order to avoid risks of excessive ions in drinking water caused by permeation of excessive scale-inhibiting ions formed on the RO membrane, in this step S300, the second cleaning passage is in communication with the raw water and cleans the RO membrane by using the raw water, thereby rinsing and taking away the ions on the RO membrane. At this point, the RO membrane is in a state of not producing pure water, thus the raw water will form a scouring on the RO membrane. The second preset time is the operation time of the booster pump, which may be set artificially, and can also be a fixed time. The present application does not make any limitation to this.

Similarly, in this embodiment, the second cleaning passage may be configured as an independent pipeline, and may also share part of the pipelines with the water production passage, the first cleaning passage and the draining passage. For example, when the second cleaning passage is configured as an independent pipeline, a connection pipe may be set between the raw water pipeline and the RO membrane element, by which connection pipe the raw water is introduced into the RO membrane element, and at the same time, a pure water opening of the RO membrane element is closed. When the second cleaning passage shares part of the pipeline with the water production passage, the first cleaning passage and the draining passage, the second cleaning passage may be formed by additionally setting a valve on the existing water production passage, first cleaning passage and draining passage of the water purifier, or by controlling opening and closing of the existing valve.

It may be seen that, in this embodiment, the second cleaning passage may have a plurality of configuration forms, and the present application does not make any limitation to this.

What needs to be explained is that, the step S300 and the previous step S200 do not have a clear execution sequence relationship therebetween. The step S300 may be executed before the step S200, and can also be executed thereafter. The present application does not make any limitation to this. Preferably, sequentially executing the steps S100, S200 and S300 may be taken as the preferred solution.

As a feasible embodiment, the control method for a water purifier provided by this embodiment may also comprise:

S50: establishing a water production passage which is in communication with raw water and through which pure water is produced.

In this step, the water purifier produces water by means of the RO membrane element, which may be executed according to a water production instruction given by a user, and the step S50 may also be actuated automatically by monitoring the on and off of a water passing device (such as a tap and a water heater) and whether there is a flow therethrough. When the water purifier establishes the water production passage, the water production passage may be established by controlling the opening and closing of the valve.

When the water purifier produces pure water, there is a need to apply a certain pressure to the raw water to pass through the RO membrane element by means of the booster pump, thereby filtering the raw water into pure water and waste water. The water production passage may include, but not limited to: the booster pump, the RO membrane element and the waste water proportioner which are in sequential communication. Of course, a water inlet valve connected to the raw water pipeline may be provided in front of the booster pump, by controlling the opening and closing of which water inlet valve the water production passage is established. In addition, the water production passage may also be provided with other valves, control elements and pipe members, so as to realize the effects of multilevel control, connections to other pipelines or improvement of the integration level of the pipelines.

Further, the water production passage may be provided with a scale inhibiting mechanism which may be provided upstream of the waste water proportioner, so that the scale inhibiting mechanism prevents scaling in the waste water proportioner, which will affect the service life of the waste water proportioner. Of course, the specific position of the scale inhibiting mechanism may be set flexibly. It may be set upstream of the RO membrane element, and can also be set downstream of the RO membrane element. The present application does not make any limitation to this.

It may be seen that in this embodiment the water production passage may have a plurality of connection configurations. It may be a pipeline that has a function of independent water production, and may also share part of the element and pipe with other pipelines (the first cleaning passage, the second cleaning passage and the draining passage). Therefore, the present application does not make any limitation to the specific connection configuration of the water production pipeline, provided that the purpose of producing pure water by the water production passage may be achieved.

What needs to be explained is that, the step S50 and the step S100 do not have a clear execution sequence relationship therebetween. The step S50 may be executed before the step S100, and can also be executed after the step S100. The present application does not make any limitation to this.

In addition, the step S50 and the step S100 may also be executed simultaneously, i.e., the water production passage and the first cleaning passage are established simultaneously, thereby achieving the purpose of producing pure water while finishing cleaning of the RO membrane element, which can not only improve the water production rate of the raw water, but can also effectively improve the cleaning efficiency. The waste water proportioner can discharge water during the water production and cleaning process, and can also discharge water at a regular time after the water production and cleaning have been carried on for a certain period of time.

Of course, the steps S100, S200 and S300 may be executed before the step S50, and can also be executed after the step S50. The present application also does not make any limitation to this.

In a specific embodiment, the water purifier may include the water inlet valve, the booster pump, the RO membrane element, the scale inhibiting mechanism and the waste water proportioner which are connected in sequence.

The step S50 includes: opening the water inlet valve to establish the water production passage, and controlling the booster pump to run to produce pure water.

In this embodiment, the water inlet valve may be connected to a raw water pipeline, the booster pump pressurizes the raw water to enable reverse osmosis of the raw water to the pure water side of the RO membrane, and the waste water proportioner can provide a certain resistance for drainage of the waste water, thereby ensuring effective production of pure water and guaranteeing the water quality of the produced pure water. The scale inhibiting mechanism is provided downstream of the RO membrane element and upstream of the waste water proportioner, so that the waste water enters the waste water proportioner after passing through the scale inhibiting mechanism, which effectively avoids scaling in the waste water proportioner. Meanwhile, when the scale inhibiting mechanism is located downstream of the RO membrane element, compared to the case where the scale inhibiting mechanism is located upstream of the RO membrane element, during water production, the ions generated by dissolution of the scale inhibitor in the scale inhibiting mechanism will not contact the RO membrane, and thus will not lead to the problem of excessive ions on the pure water side of the RO membrane during the water production.

For better automatic control, the water inlet valve may be an electric control valve (such as a solenoid valve; and can also be a signal control valve, while the present application does not make any limitation to this). A pure water outlet of the RO membrane element is generally connected to a tap or other water supply and water storage equipments. The water purifier, upon receiving a flow signal from the tap or from the other water supply and water storage equipments, can control the water inlet valve to open, so as to establish the water production passage and thereby produce pure water.

In a feasible embodiment, to continue with the configuration of the water production passage in the above embodiments, a water outlet of the scale inhibiting mechanism is in communication with a water inlet of the booster pump.

The steps S50 and S100 may include: opening the water inlet valve to simultaneously establish the water production passage and the first cleaning passage; and controlling the booster pump to run so as to product pure water and at the same time cause the scale inhibiting mechanism to clean the RO membrane element.

By such a setting, the raw water is introduced into the first cleaning passage. On the basis of supplying raw water, the RO membrane element can start the water production. At this point, the water production passage and the first cleaning passage are established simultaneously, the waste water entered the scale inhibiting mechanism after being discharged from the RO membrane element will converge with the raw water again, and thereafter enter the RO membrane element again for the water production. This can not only improve the water production rate, but can also effectively improve the cleaning efficiency.

In another embodiment, to continue with the configuration of the water production passage in the above embodiments, a water outlet of the scale inhibiting mechanism is in communication with a water inlet of the booster pump, and a first switch valve is provided therebetween.

Said establishing a water production passage which is in communication with raw water also includes closing the first switch valve. Namely, the step S50 includes: opening the water inlet valve and closing the first switch valve to establish the water production passage, and controlling the booster pump to run to product pure water.

The step S100 includes: opening the first switch valve and closing the water inlet valve to establish the first cleaning passage, and controlling the booster pump to run for the first preset time to cause the scale inhibiting mechanism to clean the RO membrane element of the water purifier.

It can be seen that the first cleaning passage in this embodiment uses part of the pipeline of the above water production passage, and suctions the liquid in the scale inhibiting mechanism onto the RO membrane element by means of the booster pump, thereby finishing the cleaning of the RO membrane element. To be specific, the water outlet of the scale inhibiting mechanism and the water inlet of the booster pump are connected by a pipe on which the first switch valve is provided. Similarly, the first switch valve may be an electric control valve (such as a solenoid valve; and can also be a signal control valve, while the present application does not make any limitation to this). The water purifier can execute the step S100 in a time period of not producing water. Preferably, the water purifier can select a time period of not using water which is reasonable in both time location and time length to execute and accomplish the step S100.

Further, said controlling the booster pump to run for the first preset time to cause the scale inhibiting mechanism to clean the RO membrane element of the water purifier includes: controlling the booster pump to run for the first preset time to cause the scale inhibiting mechanism to circularly clean the RO membrane element of the water purifier. Namely, the step S100 includes: opening the first switch valve and closing the water inlet valve to establish the first cleaning passage, and controlling the booster pump to run for the first preset time to cause the scale inhibiting mechanism to circularly clean the RO membrane element of the RO membrane element.

Since the pipeline configuration of the water production passage is continued to be used, the first cleaning passage established after the first switch valve is opened and the water inlet valve is closed is configured as a circulation pipeline. In order to achieve a better cleaning effect, the scale inhibiting mechanism may be made to circularly clean the RO membrane element of the water purifier. The first preset time is the operation time of the booster pump, which may be set artificially, and can also be a fixed time. The present application does not make any limitation to this.

In addition, in this embodiment, it is possible to simultaneously establish the water production passage and the first cleaning passage by opening the water inlet valve (at this point the first switch valve is opened), and it is also possible to produce pure water and at the same time cause the scale inhibiting mechanism to clean the RO membrane element by controlling the booster pump to run.

In a preferred embodiment, to continue with the above mentioned first cleaning passage, a second switch valve may be provided between the water outlet of the RO membrane element and the water inlet of the scale inhibiting mechanism; the waste water outlet of the RO membrane element is connected with a flush valve.

Said establishing a water production passage which is in communication with raw water also includes opening the second switch valve and closing the flush valve. Namely, the step S50 includes: opening the water inlet valve and the second switch valve, and closing the first switch valve and the flush valve, so as to establish the water production passage; and controlling the booster pump to run to produce pure water.

Said establishing a first cleaning passage which communicates a scale inhibiting mechanism with an RO membrane element of the water purifier further includes: opening the second switch valve and closing the flush valve. Namely, the step S100 includes: opening the first switch valve and the second switch valve, and closing the water inlet valve and the flush valve, so as to establish the first cleaning passage; and controlling the booster pump to run for the first preset time to cause the scale inhibiting mechanism to clean the RO membrane element of the water purifier.

The step S200 includes: opening the first switch valve and the flush valve, and closing the water inlet valve and the second switch valve, so as to establish the draining passage; and controlling the booster pump to run for a third preset time to drain the liquid in the scale inhibiting mechanism.

In this embodiment, the draining passage further utilizes part of the pipelines of the above mentioned water production passage and first cleaning passage, and suctions, by means of the booster pump, the liquid in the scale inhibiting mechanism which is then discharged after passing through the RO membrane element and the flush valve, thus the draining work for the scale inhibiting mechanism is finished, and the problem that the scale inhibitor is still immersed in the liquid when not using water is avoided.

To be specific, a three-way structure may be used for connections between the second switch valve, the RO membrane element and the flush valve. The flush valve may be connected with a drainage pipe through which the liquid in the scale inhibiting mechanism is discharged. Similarly, both the second switch valve and the flush valve may be electric control valves (such as solenoid valves; and can also be signal control valves, while the present application does not make any limitation to this). The water purifier can execute the step S200 in the time period of not producing water. Preferably, the water purifier can select a time period of not using water which is reasonable in both time location and time length to execute and accomplish the step S200. The third preset time is the operation time of the booster pump, which may be set artificially, and can also be a fixed time, and the present application does not make any limitation to this.

Further, to continue with the above pipeline configuration, the step S300 includes: opening the water inlet valve and the flush valve, and closing the first switch valve and the second switch valve, so as to establish the second cleaning passage; and controlling the booster pump to run for the second preset time to clean the RO membrane element with the raw water.

In the step S300, the water purifier can establish the second cleaning passage just by controlling the opening and closing of the valve, while no additional pipe or device is demanded, which not only reduces the manufacture costs, but can also effectively prevent occurrence of the problem of excessive ions.

It can be seen from the above depiction that, by establishing the draining passage connected to the scale inhibiting mechanism, the control method for a water purifier provided by the present application can drain the liquid in the scale inhibiting mechanism in a state of not producing water, thereby effectively preventing the scale inhibitor in the scale inhibiting mechanism from being consumed too fast as it is in a dissolved state all the way. Meanwhile, in the method, the first cleaning passage is also established to realize the cleaning work of the RO membrane element, which can effectively avoid the problem of blockage of the RO membrane element and prolong the service life of the RO membrane element. In addition, in the method the second cleaning passage is also established, and by such a setting the scale-inhibiting ions on the RO membrane may be rinsed, thereby avoiding the problem of excessive ions caused by the scale-inhibiting ions permeating to the pure water side of the RO membrane.

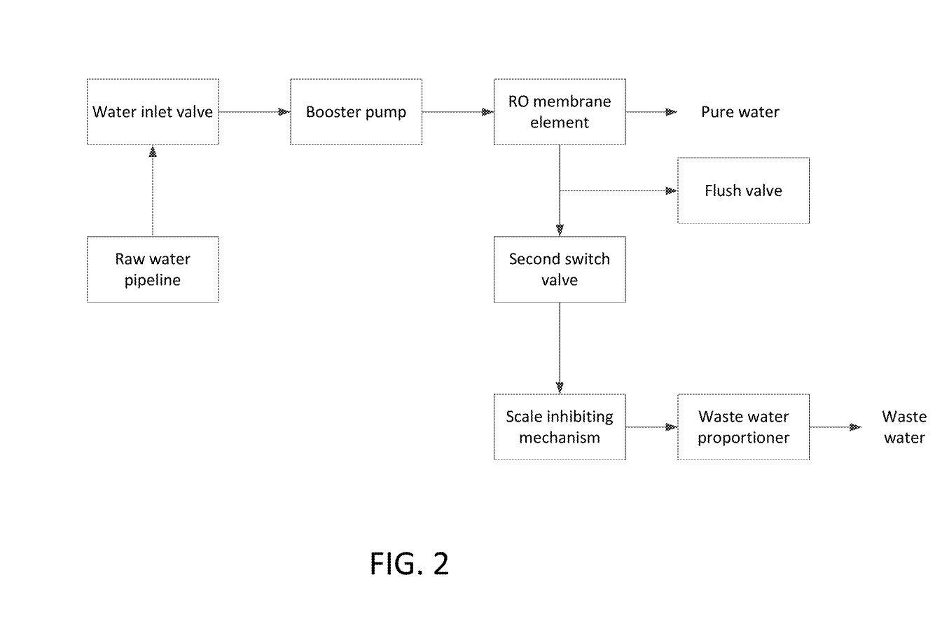

Please refer to FIG. 2. Another embodiment of the present application also provides a water purifier, comprising: a water inlet valve, a booster pump, an RO membrane element, a scale inhibiting mechanism and a waste water proportioner which are connected in sequence; the scale inhibiting mechanism is connected with a draining passage capable of draining liquid in the scaling inhibition mechanism.

In this embodiment, the water purifier may be provided with an independent pipeline to establish the draining passage together with the scale inhibiting mechanism, so as to drain the liquid in the scale inhibiting mechanism, whereby the dissolution caused by long-term immersion of the scale exhibition mechanism in the liquid is avoided, and the scale inhibitor is prevented from being consumed too fast, so that the service life of the scale inhibiting mechanism may be effectively prolonged.

The draining passage may be configured as an independent pipeline, and may also work together with the water production passage and the cleaning passage in the water purifier. For example, when the draining passage is configured as an individual pipeline, the scale inhibiting mechanism may be connected with a discharge pipe and a suction device, meanwhile, the scale inhibiting mechanism is isolated in a cleaning or water production pipeline when draining the liquid. To be specific, the scale inhibiting mechanism may be isolated by additionally setting a valve. When the draining passage cooperates with the water production passage and the cleaning passage, the draining passage may be formed by setting a valve on the existing water production passage and cleaning passage of the water purifier, or by controlling opening and closing of the existing valve.

It can be seen that, in this embodiment, the draining passage may have a plurality of configuration forms, and the present application does not make any limitation to this. Of course, when emptying the scale inhibiting mechanism, in order to balance a pressure inside the scale inhibiting mechanism, the existing waste water proportioner may be used to perform an air intake balancing, and it is also feasible to provide an additional pressure balancing mechanism to ensure smooth operation of the draining work.

When draining the liquid in the scale inhibiting mechanism, the suction mechanism may be the booster pump on the water production passage, and may also be the driving mechanism on the cleaning passage, and of course may also be provided individually. For purposes of saving costs and improving the integration level of the pipelines, both the suction mechanism and the driving mechanism may be the booster pump on the water production passage.

In this embodiment, the water inlet valve, the booster pump, the RO membrane element, the scale inhibiting mechanism and the waste water proportioner are connected to one another by pipes, wherein, a waste water outlet of the RO membrane element is connected to a water inlet of the scale inhibiting mechanism, a water outlet of the scale inhibiting mechanism is connected to a water inlet of the waste water proportioner, and the waste water proportioner discharges the waste water. The scale inhibiting mechanism may contain at least one scale inhibitor which is selected from one or more of an organophosphorus scale inhibitor, a polycarboxylic acid anti-scaling dispersant, a compound scale inhibitor, an RO scale inhibitor, a condensed scale inhibitor and a phosphate-free scale inhibitor. Preferably, the scale inhibiting mechanism may contain a sili phos-containing scale inhibitor.

In this embodiment, the water inlet valve may be connected to a raw water pipeline, the water production passage may be established after the water inlet valve is opened, and pure water may be produced through the water production passage. In the water production passage, the booster pump pressurizes the raw water to enable reverse osmosis of the raw water to the pure water side of the RO membrane, and the waste water proportioner can provide a certain resistance for drainage of the waste water, thereby ensuring effective production of pure water and guaranteeing the water quality of the produced pure water.

The scale inhibiting mechanism is provided downstream of the RO membrane element and upstream of the waste water proportioner, so that waste water enters the waste water proportioner after passing through the scale inhibiting mechanism, which effectively avoids scaling in the waste water proportioner. Meanwhile, when the scale inhibiting mechanism is located downstream of the RO membrane element, compared to the case where the scale inhibiting mechanism is located upstream of the RO membrane element, during water production, the ions generated by dissolution of the scale inhibitor in the scale inhibiting mechanism will not contact the RO membrane, and thus will not lead to the problem of excessive ions on the pure water side of the RO membrane during the water production.

For better automatic control, the water inlet valve may be an electric control valve (such as a solenoid valve; and can also be a signal control valve, while the present application does not make any limitation to this). A pure water outlet of the RO membrane element is generally connected to a tap or other water supply and water storage equipments. The water purifier, upon receiving a flow signal from the tap or from the other water supply and water storage equipments, can control the water inlet valve to open to establish the water production passage, thereby producing pure water.

The water outlet of the scale inhibiting mechanism is in communication with the water inlet of the booster pump, and a first switch valve is provided therebetween. By setting the first switch valve, it is possible to establish the first cleaning passage in the water purifier. To be specific, the first cleaning passage may be established just by opening the first switch valve and closing the water inlet valve. In the first cleaning passage, controlling the booster pump to run for the first preset time can enable the scale inhibiting mechanism to clean the RO membrane element of the water purifier.

The first cleaning passage established in this embodiment applies part of the pipeline of the above mentioned water production passage, and suctions the liquid in the scale inhibiting mechanism onto the RO membrane element by means of the booster pump, thereby finishing the cleaning of the RO membrane element. To be specific, the water outlet of the scale inhibiting mechanism and the water inlet of the booster pump are connected by a pipe on which the first switch valve is provided. Similarly, the first switch valve may be an electric control valve (such as a solenoid valve; and can also be a signal control valve, while the present application does not make any limitation to this). The water purifier can execute the cleaning of the RO membrane element in a time period of not producing water. Preferably, the water purifier can select a time period of not using water which is reasonable in both time location and time length to execute and accomplish the cleaning of the RO membrane element.

In a preferred embodiment, a second switch valve may be provided between the water outlet of the RO membrane element and the water inlet of the scale inhibiting mechanism; the waste water outlet of the RO membrane element is connected with a flush valve. The draining passage is established when the first switch valve and the flush valve are opened and the water inlet valve and the second switch valve are closed, and the booster pump is able to run to drain the liquid in the scale inhibiting mechanism.

In this embodiment, the draining passage further employs part of the pipelines of the above mentioned water production passage and first cleaning passage, which improves the integration level and saves manufacture costs; meanwhile, the draining passage suctions, by means of the booster pump, the liquid in the scale inhibiting mechanism which is then discharged after passing through the RO membrane element and the flush valve, thus the draining work of the scale inhibiting mechanism is finished, and the problem that the scale inhibitor is still immersed in the liquid when not using water is avoided.

To be specific, a three-way structure may be used for connections between the second switch valve, the RO membrane element and the flush valve. The flush valve may be connected to a drainage pipe through which the liquid in the scale inhibiting mechanism is discharged. Similarly, both the second switch valve and the flush valve may be electric control valves (such as solenoid valves; and can also be signal control valves, while the present application does not make any limitation to this). The water purifier can execute the draining work in a time period of not producing water. Preferably, the water purifier can select a time period of not using water which is reasonable in both time location and time length to execute and accomplish the draining work.

Further, to continue with the above pipeline configuration, in this embodiment, the second cleaning passage can also be established by opening the water inlet valve and the flush valve and closing the first switch valve and the second switch valve. In the second cleaning passage, by controlling the booster pump to run for the second preset time the RO membrane element may be cleaned with the raw water.

Although the RO membrane is cleaned with the liquid containing a scale inhibitor in the cleaning process of the first cleaning passage to prevent scaling and blockage of the RO membrane, it is possible that scale-inhibiting ions (such as phosphorus) are still remained on the RO membrane. Therefore, in order to avoid risks of excessive ions in drinking water caused by permeation of excessive scale-inhibiting ions formed on the RO membrane, the second cleaning passage is in communication with the raw water and cleans the RO membrane by using the raw water, thereby rinsing and taking away the ions on the RO membrane. At this point, the RO membrane is in a state of not producing pure water, thus the raw water will form a scouring on the RO membrane.

The water inlet valve, the flush valve, the first switch valve and the second switch valve can all be solenoid valves. The water purifier further comprises a controller connected to each of the water inlet valve, the flush valve, the first switch valve and the second switch valve. The controller can realize respective establishments of the above mentioned water production passage, first cleaning passage, draining passage and second cleaning passage by control of the water inlet valve, the flush valve, the first switch valve and the second switch valve, thereby executing different works.

Any numerical value cited in this text includes all values including the lower and the upper values, in increments of one unit, between the lower limiting value to the upper limiting value, provided that there is a separation of at least two units between any lower value and any higher value. For example, if it is elaborated that the value of the number of a component or of a process variable (such as temperature, pressure, time, etc.) is from 1 to 90, preferably from 20-80, and more preferably from 30-70, then the purpose is to illustrate that the Description also explicitly lists the values such as from 15-85, from 22 to 68, from 43 to 51 and from 30 to 32. As for values smaller than 1, it shall be appreciated appropriately that one unit is 0.0001, 0.001, 0.01 or 0.1. These are only examples for explicit expression, and it may be regarded that all possible combinations of values listed between the minimum value and the maximum value have been explicitly elaborated in a similar way in the Description.

Unless otherwise stated, all ranges include the endpoints and all numbers that fall between the endpoints. The use of “about” or “approximately” together with a range applies to both ends of the range. Therefore, the expression “about 20 to 30” is intended to cover “about 20 to about 30”, and at least includes the expressly pointed out endpoints.

The disclosures of all articles and references, including patent applications and publications, are incorporated therein by reference for all purposes. The term “substantially consists of . . . ” which describes a combination should include the determined elements, components, parts or steps, as well as other elements, components, parts or steps that in substance do not affect the basic novel features of the combination. The use of terms “contain” or “comprise” to describe the combination of the elements, components, parts or steps therein also take into account the embodiment substantially constructed by these elements, components, parts or steps. Here, by using the term “can”, it is intended to explain that any described attribute that “can” be included is selectable.

Multiple elements, components, parts or steps may be provided by a single integral element, component, part or step. Alternatively, a single integral element, component, part or step may be divided into a plurality of separated elements, components, parts or steps. The terms “a” or “one” used to describe the elements, components, parts or steps are not intended to exclude other elements, components, parts or steps.

It should be understood that the above description is for graphic illustration rather than limitation. By reading the above description, many embodiments and applications other than the provided examples would be obvious for persons skilled in the art. Therefore, the scope of the teaching should be determined not with reference to the above description, but should instead be determined with reference to the appended claims, along with the full scope of equivalents possessed by the claims. The disclosures of all articles and references, including patent applications and publications, are incorporated herein by reference for purpose of being comprehensive. The omission in the foregoing claims of any aspect of the subject matter that is disclosed herein is not a disclaimer of such subject matter, nor should it be regarded that the inventor did not consider such subject matter to be part of the disclosed inventive subject matter.

Thus, the application provides, among other things, a {text}. Various features and advantages of the application are set forth in the following claims.

What is claimed is:

1. A control method for a water purifier comprising:
establishing a first cleaning passage which communicates a scale inhibiting mechanism with an RO membrane element of the water purifier and through which the scale inhibiting mechanism cleans the RO membrane element for a first preset time;
establishing a draining passage which is connected to the scale inhibiting mechanism and through which liquid in the scale inhibiting mechanism is drained out; and
establishing a second cleaning passage which is in communication with raw water and through which the RO membrane element is cleaned with the raw water for a second preset time.

2. The control method according to claim 1, further comprising establishing a water production passage which is in communication with the raw water and through which pure water is produced.

3. The control method according to claim 2, wherein the water purifier includes a water inlet valve, a booster pump, the RO membrane element, the scale inhibiting mechanism and a waste water proportioner which are connected in sequence, and establishing a water production passage further includes:
opening the water inlet valve to establish the water production passage, and controlling the booster pump to run to produce pure water.

4. The method of claim 3, further comprising a water outlet of the scale inhibiting mechanism is in communication with a water inlet of the booster pump, and establishing a water production passage and establishing a first cleaning passage further includes:
opening the water inlet valve to simultaneously establish the water production passage and the first cleaning passage, and
controlling the booster pump to run so as to produce pure water and cause the scale inhibiting mechanism to clean the RO membrane element at the same time.

5. The method of claim 3, further comprising a water outlet of the scale inhibiting mechanism in communication with a water inlet of the booster pump, and a first switch valve provided therebetween, wherein establishing a water production passage further includes closing the first switch valve, and establishing a first cleaning passage further includes:
opening the first switch valve and closing the water inlet valve to establish the first cleaning passage, and
controlling the booster pump to run for the first preset time to cause the scale inhibiting mechanism to clean the RO membrane element of the water purifier.

6. The method of claim 5, wherein controlling the booster pump further includes controlling the booster pump to run for the first preset time to cause the scale inhibiting mechanism to circularly clean the RO membrane element of the water purifier.

7. The method of claim 5, further comprising a second switch valve between a water outlet of the RO membrane element and a water inlet of the scale inhibiting mechanism;
a waste water outlet of the RO membrane element is connected with a flush valve;
wherein establishing a water production passage further includes opening the second switch valve and closing the flush valve;
wherein establishing a first cleaning passage further includes opening the second switch valve and closing the flush valve;
wherein establishing a draining further includes: opening the first switch valve and the flush valve, and closing the water inlet valve and the second switch valve to establish the draining passage, and controlling the booster pump to run for a third preset time to drain the liquid in the scaling inhibition mechanism.

8. The method of claim 7, wherein establishing a second cleaning passage further includes:
opening the water inlet valve and the flush valve, and closing the first switch valve and the second switch valve to establish the second cleaning passage, and
controlling the booster pump to run for the second preset time to clean the RO membrane element.

9. A water purifier comprising:
a water inlet valve;
a booster pump;
an RO membrane element; and
a scale inhibiting mechanism and a waste water proportioner which are connected in sequence, the scale inhibiting mechanism being connected with a draining passage capable of draining liquid in the scaling inhibition mechanism.

10. The water purifier of claim 9, further comprising a water outlet of the scale inhibiting mechanism in communication with a water inlet of the booster pump, and a first switch valve provided therebetween.

11. The water purifier according to claim 10, further comprising:
a second switch valve between a water outlet of the RO membrane element and a water inlet of the scale inhibiting mechanism;
a waste water outlet of the RO membrane element is connected with a flush valve; the draining passage is established when the first switch valve and the flush valve are opened and the water inlet valve and the second switch valve are closed; and
the booster pump is able to run to drain the liquid in the scale inhibiting mechanism.

12. The water purifier of claim 11, wherein the water inlet valve, the flush valve, the first switch valve and the second switch valve are solenoid valves, and wherein the water purifier further includes a controller connected to each of the water inlet valve, the flush valve, the first switch valve and the second switch valve.

13. The water purifier of claim 9, wherein the scale inhibiting mechanism further includes a sili phos scale inhibitor.

14. A water purifier, comprising:
a water inlet valve;
a booster pump;
an RO membrane element; and
a scale inhibiting mechanism and a waste water proportioner connected in sequence.

15. The water purifier according to claim 14, further comprising a water outlet of the scale inhibiting mechanism in communication with a water inlet of the booster pump.

16. The water purifier according to claim 15, wherein the water outlet of the scale inhibiting mechanism is in communication with the water inlet of the booster pump, and a first switch valve is provided therebetween.

17. A control method for the water purifier according to claim 14, further comprising opening the water inlet valve to establish a water production passage, and controlling the booster pump to run to produce pure water.

18. The method of claim 17, wherein a water outlet of the scale inhibiting mechanism is in communication with a water inlet of the booster pump, the method further comprising:
opening the water inlet valve to simultaneously establish the water production passage and a first cleaning passage; and
controlling the booster pump to run so as to produce pure water and at the same time cause the scale inhibiting mechanism to clean the RO membrane element.

19. The method according to claim 17, wherein a water outlet of the scale inhibiting mechanism is in communication with a water inlet of the booster pump, and a first switch valve is provided therebetween, and the method further comprising:
opening the water inlet valve and closing the first switch valve to establish the water production passage, and controlling the booster pump to run to produce pure water;
opening the first switch valve and the water inlet valve to simultaneously establish the water production passage and the first cleaning passage; and
controlling the booster pump to run so as to produce pure water and at the same time cause the scale inhibiting mechanism to clean the RO membrane element.

20. The method according to claim 17, further comprising opening the water inlet valve to establish the water production passage, and controlling the booster pump to run to produce pure water and clean the waste water proportioner.
